(19) United States
(12) Patent Application Publication
(10) Pub. No.: US 2020/0320383 A1
(43) Pub. Date: Oct. 8, 2020

(54) COMPLETE PROCESS TRACE PREDICTION USING MULTIMODAL ATTRIBUTES

(71) Applicant: International Business Machines Corporation, Armonk, NY (US)

(72) Inventors: Sampath Dechu, Bangalore (IN); Monika Gupta, Bangalore (IN); Tarun Tater, Bangalore (IN); Daivik Swarup Swarup Oggu Venkata, Bangalore (IN)

(21) Appl. No.: 16/376,209

(22) Filed: Apr. 5, 2019

(51) Int. Cl. G06N 3/08; G06N 20/00

(52) U.S. Cl. CPC G06N 3/08; G06N 20/00

(57) ABSTRACT

Methods, systems, and computer program products for complete trace prediction of process instance using multimodal attributes are provided herein. A computer-implemented method includes receiving a request to resolve an issue related to a product and/or a service, wherein the request comprises multimodal data corresponding to at least two modalities; creating a case based on the request, wherein the case comprises a plurality of case attributes corresponding to (i) queue state information related to a status of other pending requests and (ii) the multimodal data; generating a vector representation for the case based on the plurality of case attributes; providing the vector representation as input to a joint machine learning model to determine a sequence of events for resolving the issue, wherein the joint machine learning model is trained based at least in part on prior requests and sequences of events corresponding to the prior requests.

### FIELD

The present application generally relates to information technology and, more particularly, to process trace prediction.

### BACKGROUND

Increasingly, businesses are relying on process management software applications to help, for example, analyze, optimize, and automate various business processes. Typically, such applications rely on a partially executed process trace for a given case to predict the next activity, but do not account for multimodal data related to the case, thereby limiting their functionality and efficiency.

### SUMMARY

In one embodiment of the present invention, techniques for complete trace prediction of a process instance using multimodal attributes are provided. An exemplary computer-implemented method includes receiving a request from a user to resolve an issue related to one or more of a product and a service, wherein the request comprises multimodal data corresponding to at least two modalities. The process includes creating a case based on the request, wherein the case comprises a plurality of case attributes. The process also includes generating vector representations for (i) each of the at least two modalities based on the multimodal data and (ii) the case based on the case attributes. Additionally, the process includes providing the vector representations as input to a joint machine learning model to determine a sequence of events for resolving the issue, wherein the joint machine learning model is trained based at least in part on prior requests and sequences of events corresponding to the prior requests. The process may also include outputting said determined sequence of events for resolving the issue to one or more additional users.

Another example embodiment includes a computer-implemented method including obtaining a joint machine learning model for determining a complete trace for processing requests related to one or more of a product and a service, wherein the joint machine learning model is trained based at least in part on historical requests and sequences of events corresponding to the historical requests; receiving a new request related to the one or more of the product and the service, the new request comprising data corresponding to at least two different modalities; obtaining queue information corresponding to a status of at least one other pending request; generating a combined vector representation of the new request, wherein said generating comprises generating and concatenating vector representations of (i) the data corresponding to each of the at least two modalities and (ii) the queue information corresponding to the status of the at least one other pending request; determining a complete trace of events for processing the new request by providing the combined vector representation as input to the joint machine learning model.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture in accordance with an example embodiment of the subject matter described;

FIG. 2 is a diagram illustrating a model in accordance with one or more example embodiments of the subject matter described herein;

FIG. 3 is an example table that includes case attributes for different cases in accordance with one or more example embodiments of the subject matter described herein;

FIG. 4 is a non-limiting example of a predicted trace in accordance with one or more example embodiments of the subject matter described herein;

FIG. 5 is a flow diagram illustrating techniques according to an embodiment of the invention;

FIG. 6 is a system diagram of an exemplary computer system on which at least one embodiment of the invention can be implemented;

FIG. 7 depicts a cloud computing environment according to an embodiment of the present invention; and

FIG. 8 depicts abstraction model layers according to an embodiment of the present invention.

### DETAILED DESCRIPTION

An embodiment described herein includes predicting a complete trace for a process instance (such as a business process, for example) using multi-modal inputs available at the time the process instance is initiated. The multimodal inputs may include, for example, case features, images, comments, queue features, etc. Additionally, at least one of the example embodiments described herein includes learning a joint machine learning model that takes multimodal inputs in vector form. Such a joint machine learning model is trained to maximize the likelihood of an observed historical full event sequence (also referred to herein as a ‘trace’) for a given case vector. Further, one or more example embodiments include predicting an event sequence using the trained joint machine learning model by passing the case and queue state vectors along with image and comment embeddings as input, and iteratively generating a probability distribution over an event dictionary until an end of trace event (EOT) is observed, wherein the event dictionary is conditioned on input and previous event predictions by the model.

In some example embodiments, an image is represented in vector form using convolutional neural network (CNN), and sentences describing the image are encoded using recurrent neural network (RNN). Given an image, when the joint machine learning model is trained, the model sequentially generates a probability distribution over words in a vocabulary until an end of trace event is determined.

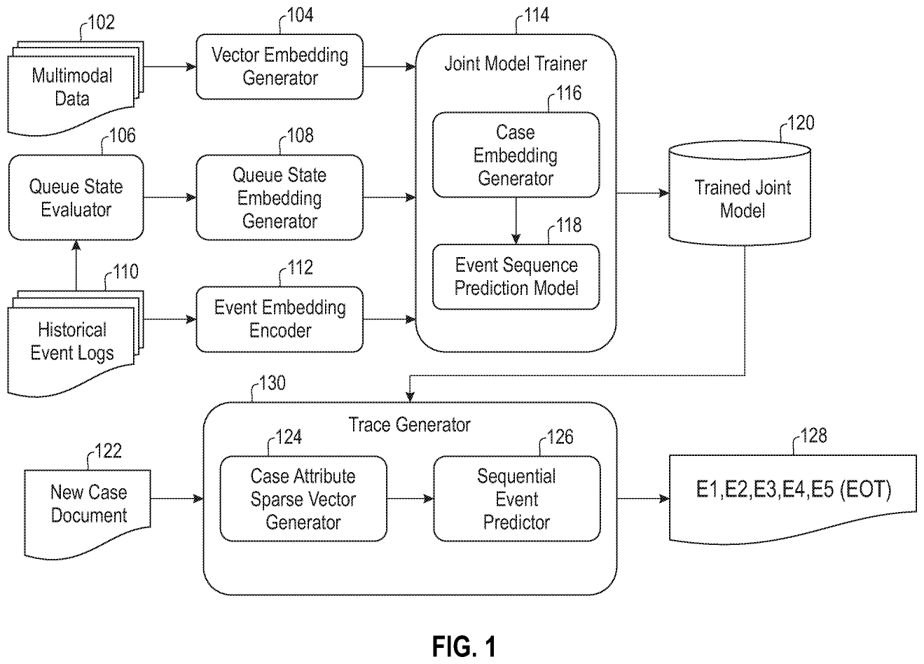

FIG. 1 is a diagram illustrating a system architecture, according to an embodiment of the invention. By way of illustration in FIG. 1, a vector embedding generator 104 generates vector embeddings for multimodal data 102. As an example, the multimodal data 102 may include data relating to images, comments, audio, video, etc. The vector embedding generator 104 may generate one or more vector embeddings for each type of data.

Also depicted in FIG. 1 is a queue state evaluator 106. The queue state evaluator 106 obtains historical event logs 110 as input. The historical event logs 110 correspond to completed events for a plurality of different cases. The queue state evaluator 106 determines queue attributes related to a state of the queue between the different cases. As used herein, a case refers to one trace (which may be an incomplete trace, for example) taken together with all of the case and event attributes. The queue state evaluator 106 provides the queue attributes to the queue state embedding generator 108 as input, which learns queue embeddings (e.g., vector representations) for each of the cases in the historical event logs 110. In this way, the historical logs 110 of other incomplete cases may be used to determine the queue state for a new case using the learned queue embeddings.

The historical event logs 110 are also provided as input to an event embedding encoder 112. The event embedding encoder 112 encodes events from the historical event logs 110 to create event embeddings (e.g., vector representations of events). For example, the event embedding encoder 112 learns an unsupervised embedding for each event as in Act2Vec, and the unsupervised task is used to predict an event from its context.

The system architecture depicted in FIG. 1 also includes a joint model trainer 114 comprising a case embedding generator 116 and an event sequence prediction model 118. The case embedding generator 116 generates case vectors for each case based on the vector embeddings of the multimodal data 102, the vectors generated by the queue state embedding generator 108, and the vectors generated by the event embedding encoder 112. For example, the vector embeddings of the multimodal data, the queue state, and the events may be concatenated to generate and/or obtain one vector for each case.

The case vectors are provided as input to the event sequence prediction model 118. The event sequence prediction model 118 learns associations between the cases and complete traces based on the case vectors and the event embeddings. The joint model trainer 114 outputs the trained joint model 120.

The trained joint model 120 is used by the trace generator 130 to predict complete traces of a new case at the time the new case is instantiated. For example, FIG. 1 depicts a new case document 122 that may include multimodal information such as, for example, comments, images, etc. The new case document 122 may also include current queue state attributes. The new case document 122 is provided as input to the trace generator 130. In the example shown in FIG. 1, the new case document 122 also includes current queue state attributes. In other example embodiments, the queue state attributes may be provided as a separate input, for example. The trace generator 130 includes a case attribute sparse vector generator 124, which generates a sparse vector for the new case document 122 based on the case attributes from new case document 122. The sparse vector is provided to the sequential event predictor 126 as input. The sequential event predictor 126 determines a complete trace 128 for the new case document 122 using the trained joint model 120. In the example depicted in FIG. 1, the complete trace 128 includes five sequential events (i.e., E1, E2, 3, E4 and E5), wherein the last event (i.e., E5) corresponds to an end of trace (EOT) event.

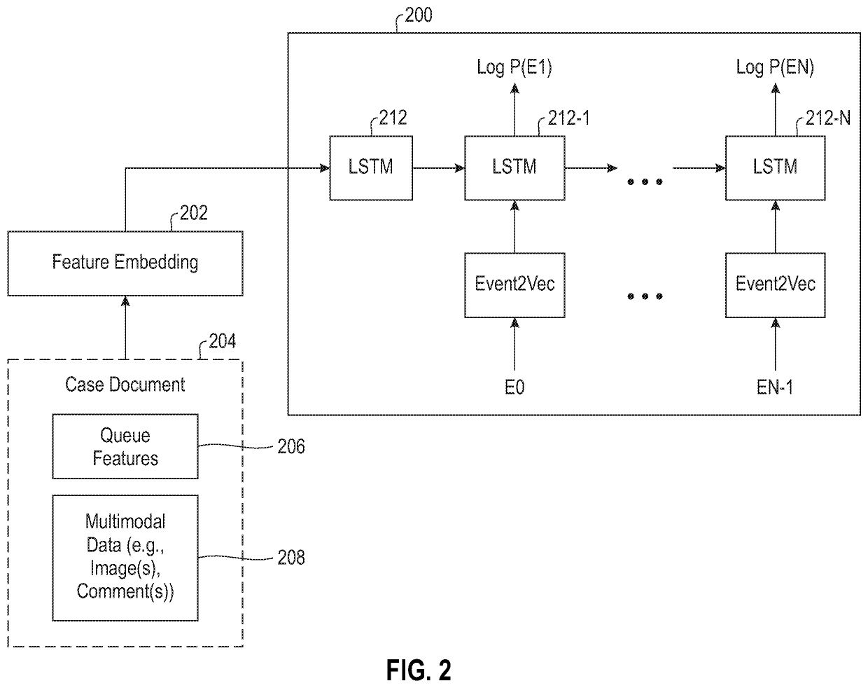

Referring now to FIG. 2, a joint model 200 is depicted in accordance with one or more example embodiments. The joint model 200 may correspond to the trained joint model 120 in FIG. 1, for example. A feature embedding 202 is generated based on the various inputs. In the example shown in FIG. 2, the inputs correspond to queue features 206 and multimodal data 208 (e.g., image(s) and comment(s)). In some example embodiments, the queue features 206 and multimodal data 208 are included in a case document 204. For example, the feature embedding 202 may correspond to a case vector corresponding to case document 204, queue features 206, and/or the multimodal data 208, such as described above with reference to FIG. 1. The joint model 200 receives the case and queue state vectors along with image and comment embeddings, and iteratively generates a probability distribution over an event dictionary that is conditioned on, for example, input and previous event predictions by the joint model 200, until an end of trace event is observed.

In FIG. 2, iterations of the LSTM 212 correspond to LSTM 212-1 . . . LSTM 212-N, and events from the event dictionary are represented as E0 . . . EN-1. Event vectors are created for the events and are provided as input to the LSTM 212 model. In the non-limiting example shown in FIG. 2, the event vectors are created using Event2Vec. At each iteration, the LSTM 212 model outputs a probability distribution for a given event represented as log P(E1) . . . log P(EN). It is noted that each of LSTM 212-1 . . . LSTM 212-N may include multiple LSTM layers.

In at least one example embodiment, the joint model is trained using one or more deep learning training algorithms. For example, according to one example embodiment, an objective function may be used as follows:

$${θ}^{*} = {arg max}_{θ} {\sum }_{( I , s )} log p ( S \vert I ; θ ) ,$$

wherein I corresponds to the input attributes of the case, S is the sequence of events or trace summation of loss over a batch, and wherein the summation of loss across an event sequence of a trace is:

$$log p ( S \vert I ) = {\sum }_{t = 0}^{N} log p ( {S}_{t} \vert I , {S}_{0} , … , {S}_{t - 1} ) .$$

Also, according to at least one example embodiment, the following model equations are used to train the joint model:

h₋₁,c₋₁=CNN(I)

∀tϵ0,1, . . . ,N−1:

xₜ=WₑSₜ

hₜ,cₜ=LSTM(xₜ,hₜ₋₁,cₜ₋₁)

Pₜ₊₁=f(hₜ)

wherein, h₋₁ and c₋₁ are the initial states for the LSTM. In this example, an image represents the case attribute and a CNN model is used to map the image to the hidden state. Wₑ the event embedding that is learned from the historical logs. xₜ is the embedding of each event, which in this example embodiment is obtained with a linear mapping of the sparse event vector, Sₜ. At each step, the LSTM produces a cell state cₜ and a hidden state hₜ, which is projected to give the probability distribution of the subsequent step.

A non-limiting example use case scenario for one or more embodiments described herein includes a customer sending a request to resolve an issue related to a product or service. For example, consider a customer who has purchased a refurbished chair in an e-commerce setting from an online retailer. The customer may find some issue with the chair upon receiving it, such as, for example, the paint on one of the chair's legs being worn off during shipment of the chair. According to at least one embodiment, the customer may file a complaint using, for instance, an online form via a graphical user interface to resolve the issue with the chair. The customer may access, for example, a system of the retailer to fill-out the online form, wherein the online form accepts multimodal input from the user (such as an image of the chair, comments describing the complaint, details about the order, etc.). The system may then create a case (or a support ticket) related to the customer's request. According to one or more example embodiments, a complete trace may then be predicted at the time the case is initiated (e.g., upon the customer submitting the form).

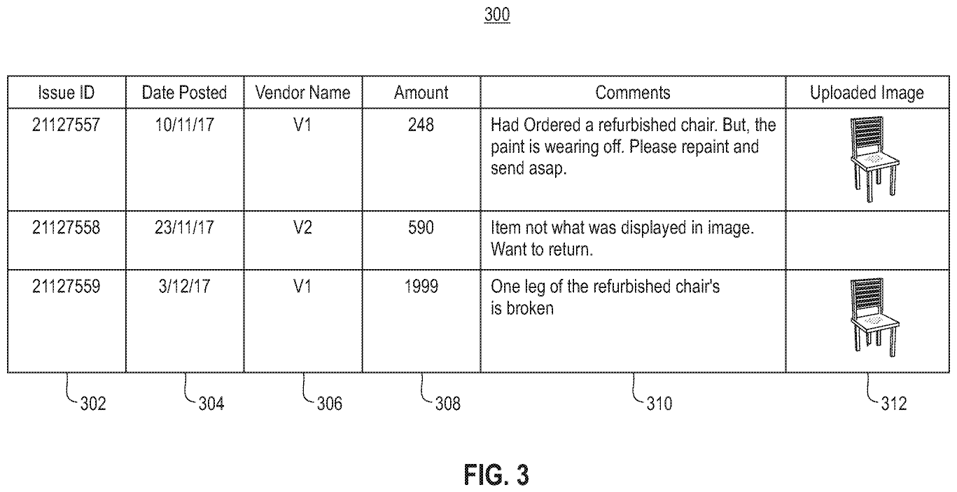

Referring also to FIG. 3, this figure shows a table 300 that includes multiple cases in accordance with one or more example embodiments. In particular, table 300 includes three cases having the following issue identifiers (IDs): 2127557, 21127558 and 217559, as indicated by column 302. The table 300 includes the following information related to each case: date the request was posted as indicated by column 304, the vendor name as indicated by column 306, the amount paid as indicated by column 308, comments from the customer's request as indicated by column 310, and uploaded images as indicated by column 312. It is to be appreciated that the table 300 may also include additional information, such as a warranty period, shipping address, category of item (e.g., furniture), etc.

Each case in table 300 may be considered a case document (such as new case document 122 in FIG. 1, for example), and at least a portion of the information from each case may correspond to case attributes of that case. Also, according to one or more example embodiments, details regarding the state of the queue are obtained (e.g., via queue state evaluator 106) such as a delivery or pickup executive assigned to the shipping address to determine the time and date when the chair is to be picked up. The additional details from the image(s) and comments provided by the customer for each case may be used to one or more of: (i) train the joint machine learning model (120) to consider these features and (ii) to predict the complete trace of the events that are likely to happen and preemptively perform one or more corrective actions. As a non-limiting example, paint being worn off a chair may be considered a minor problem, in which case an agent or third-party (e.g., a painter) may be sent to the customer to fix the issue. For a major problem (e.g., if the chair is partially destroyed in the shipping process), the system may immediately reimburse the customer and contact a vendor to arrange pick-up of the item.

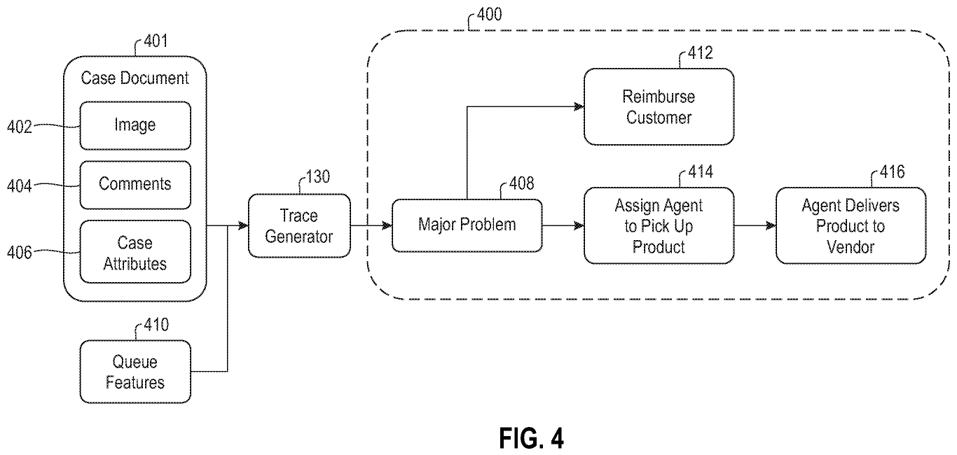

FIG. 4 depicts a non-limiting example of a complete trace 400 generated using a joint machine learning model in accordance with one or more example embodiments. In the example shown in FIG. 4, the complete trace 400 relates to an example situation (similar to above) when a customer has identified that a chair's leg has been broken. The case document 401 is created based at least in part on a request (or a complaint) submitted by the user. In this example, the case document 401 includes an image 402, comments 404 and case attributes 406. The case document 402 may be created based on one or more of: the request from the customer and information retrieved from a database (e.g., purchase date, cost, stock photos, etc., which can be obtained from a database based on an identifier provided by the customer). In the example depicted in FIG. 4, the queue features 410 are shown separately from the case document 401.

In the example shown in FIG. 4, the trace generator 130 generates embeddings (e.g., vectors) corresponding to the case document 401 and the queue state features 410, which are then used to sequentially generate the trace 400 using the trained machine learning model (such as, for example, the trained joint model 120 of FIG. 1). The first event (E1) in the trace 400 includes classifying the case (or issue in the case) as a major problem as indicated by 408. E1 may then be converted to an event vector (such as described above with reference to FIG. 2, for example). The event vector may then be provided as input to the joint training model and used to predict the next event (i.e., the next iteration). The trace generator 130 continues to iteratively predict additional events until an end of trace event is determined. In this example, the second event (E2) includes reimbursing the customer as indicated by 412, the third event (E3) includes assigning an agent to pick-up the product (i.e., the chair) as indicated by 414, and the last event (E4) includes the agent delivering the product to the vendor as indicated by 416. In some example embodiments, one or more of the events may include contacting the customer for additional information related to the issue and/or product, feedback on actions taken, etc.

In accordance with at least one example embodiment, the determination of the sequence of event considers one or more of: case-specific attributes, process-oriented attributes, importance of a given case and similarities between a given case and other cases. Case-specific attributes may include, for example, the amount of an item, vendor name of the item, category type of the item, etc. Process-oriented attributes may include, for example, sequence of actions taken on the issue, comments corresponding to specific actions taken, etc. The importance of a given case may relate to whether the customer is, for example, a frequent or a high-value customer when the current issue is raised. Similarities between a given case and other cases may correspond to a number of issues raised in the other cases that are similar to an issue of the given case within a certain time frame (e.g., within a day, month, etc.), and a number of actions (e.g., process steps) taken on all such issues.

According to at least one example embodiment, case-specific attributes and process-oriented attributes may affect the sequence of events (such as, for example, an order of the events in the sequence). An example of such might include prioritizing a given case to avoid any penalties when an invoice amount for that case is higher than a given threshold. Another example might include performing additional steps before clearing an invoice having missing information.

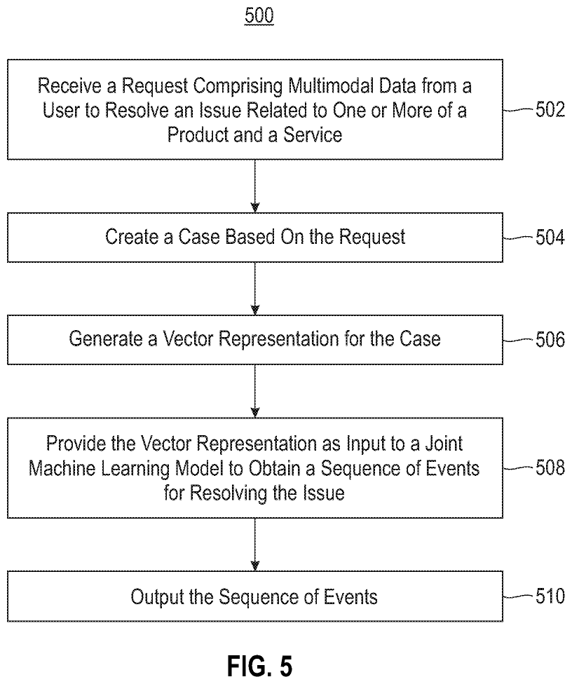

FIG. 5 is a flow diagram of a process 500 illustrating techniques according to an embodiment of the present invention. Step 502 includes receiving a request from a user to resolve an issue related to one or more of a product and a service, wherein the request comprises multimodal data corresponding to at least two modalities. Step 504 includes creating a case based on the request, wherein the case comprises a plurality of case attributes corresponding to (i) queue state information related to a status of one or more other pending requests and (ii) the multimodal data. Step 506 includes generating a vector representation for the case based at least in part on the plurality of case attributes. Step 508 includes providing the vector representation as input to a joint machine learning model to determine and/or obtain a sequence of events for resolving the issue, wherein the joint machine learning model is trained based at least in part on prior requests and sequences of events corresponding to the prior requests. Step 510 includes outputting said determined sequence of events for resolving the issue to one or more additional users.

The multimodal data of process 500 may include at least two of: text data; image data; audio data; and video data. The generating of step 506 may include generating at least one vector representation for (i) the queue state information and (ii) the data corresponding to each of the at least two modalities. The queue state information may include at least one of: a number of pending cases; a queue throughput; a number of resources; and a number of cases which have been delayed. The case attributes may include an invoice amount; an invoice date; an identifier associated with the user; an identifier associated with the one or more of product and service; and/or payment terms. According to at least one embodiment, the process 500 includes estimating a processing time for resolving the issue based on said sequence of events. The sequence of events may include one or more of: arranging a third-party to remedy the issue; initiating a return of the one or more of the product and service; and reimbursing, at least in part, the user for one or more of the service and product. The process 500 may include automatically causing performance of one or more of the outputted sequence of events. The joint machine-learning model may include two or more of: a convolutional neural network; a recurrent neural network; and a long short-term memory (LSTM) network.

An example of an embodiment comprises a method including obtaining a joint machine learning model for determining a complete trace for processing requests related to one or more of a product and a service, wherein the joint machine learning model is trained based at least in part on historical requests and sequences of events corresponding to the historical requests; receiving a new request related to the one or more of the product and the service, the new request comprising data corresponding to at least two different modalities; obtaining queue information corresponding to a status of at least one other pending request; generating a combined vector representation of the new request, wherein said generating comprises generating and concatenating vector representations of (i) the data corresponding to each of the at least two modalities and (ii) the queue information corresponding to the status of the at least one other pending request; determining a complete trace of events for processing the new request by providing the combined vector representation as input to the joint machine learning model.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

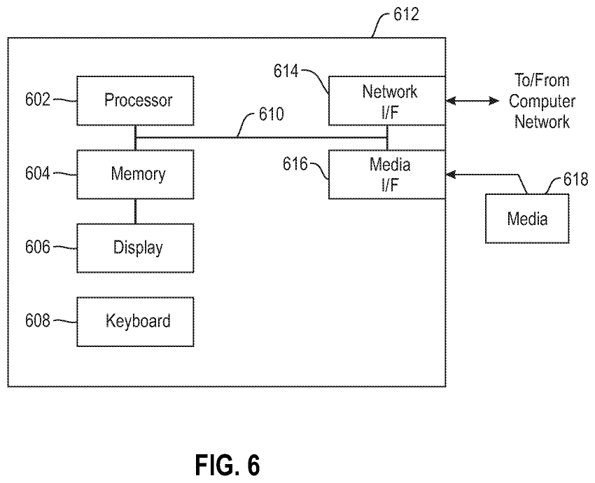

Additionally, an embodiment of the present invention can make use of software running on a computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

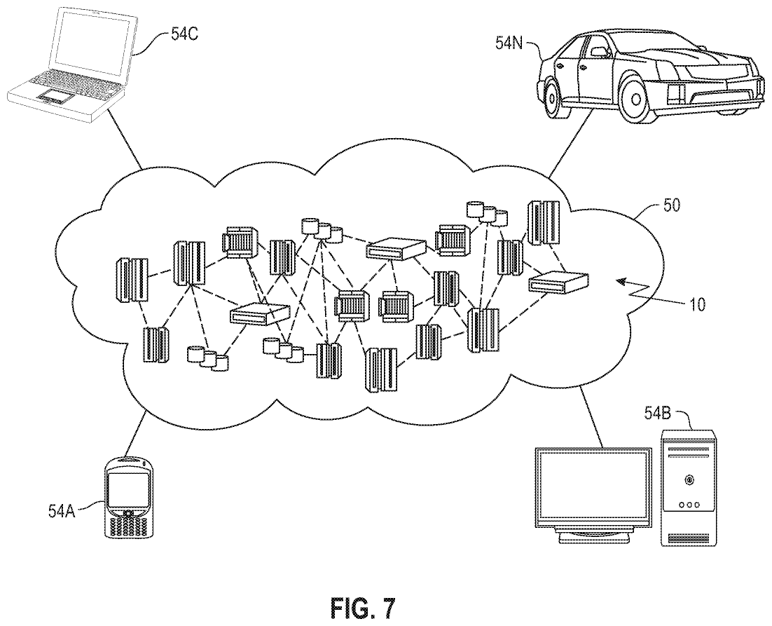

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

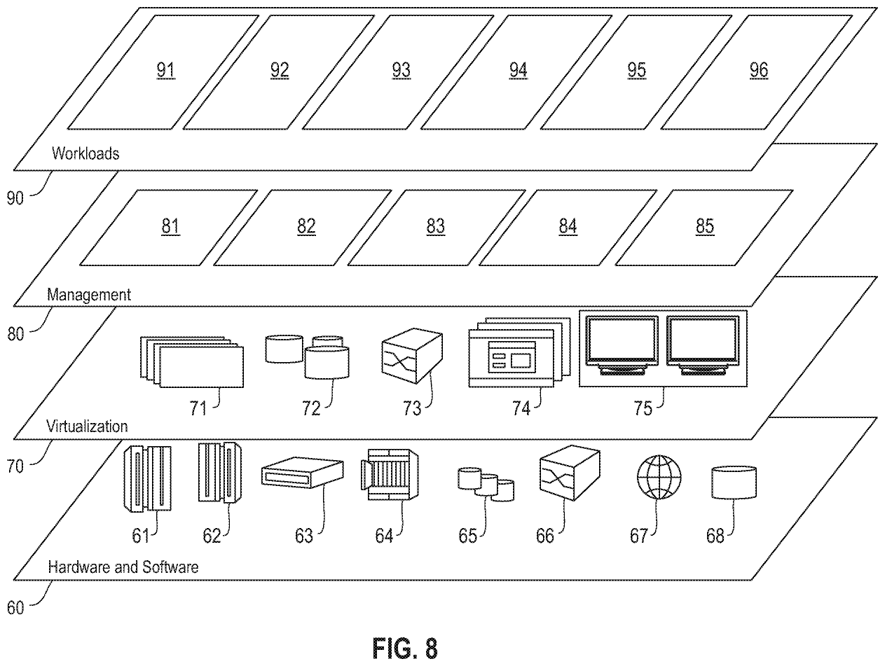

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and complete trace prediction using multimodal attributes 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, generating a complete process trace based on multimodal input at the time a case is initiated. Also, at least one embodiment of the present invention may provide a beneficial effect such as, for example, allowing users increased flexibility when providing information about an issue with particular product or service, and utilizing such information to determine a sequence of process events to be taken to remedy the issue.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a request from a user to resolve an issue related to one or more of a product and a service, wherein the request comprises multimodal data corresponding to at least two modalities;
creating a case based on the request, wherein the case comprises a plurality of case attributes corresponding to (i) queue state information related to a status of one or more other pending requests and (ii) the multimodal data;
generating a vector representation for the case based at least in part on the plurality of case attributes;
providing the vector representation as input to a joint machine learning model to determine a sequence of events for resolving the issue, wherein the joint machine learning model is trained based at least in part on prior requests and sequences of events corresponding to the prior requests; and
outputting said determined sequence of events for resolving the issue to one or more additional users;
wherein the method is carried out by at least one computing device.

2. The computer-implemented method of claim 1, wherein the multimodal data comprise at least two of:
text data;
image data;
audio data; and
video data.

3. The computer-implemented method of claim 1, wherein said generating comprises generating a vector representation for (i) the queue state information and (ii) the data corresponding to each of the at least two modalities.

4. The computer implemented method of claim 1, wherein the queue state information comprises at least one of:
a number of pending cases;
a queue throughput;
a number of resources; and
a number of cases which have been delayed.

5. The computer-implemented method of claim 1, wherein the plurality of case attributes comprises at least two of:
an invoice amount;
an invoice date;
an identifier associated with the user;
an identifier associated with the one or more of product and service; and
payment terms.

6. The computer-implemented method of claim 1, comprising:
estimating a processing time for resolving the issue based on said determined sequence of events.

7. The computer-implemented method of claim 1, wherein the determined sequence of events comprises one or more of:
arranging a third-party to remedy the issue;
initiating a return of the one or more of the product and the service; and
reimbursing, at least in part, the user for one or more of the service and product.

8. The computer-implemented method of claim 7, comprising:
automatically causing performance of one or more of the determined sequence of events.

9. The computer-implemented method of claim 1, wherein the joint machine-learning model comprises two or more of:
a convolutional neural network;
a recurrent neural network; and
a long short-term memory (LSTM) network.

10. A computer program product comprising a computer readable storage medium having program instructions embodied therewith, the program instructions executable by a computing device to cause the computing device to:
receive a request from a user to resolve an issue related to one or more of a product and a service, wherein the request comprises multimodal data corresponding to at least two modalities;
create a case based on the request, wherein the case comprises a plurality of case attributes corresponding to (i) queue state information related to a status of one or more other pending requests and (ii) the multimodal data;
generate a vector representation for the case based at least in part on the plurality of case attributes;
provide the vector representation as input to a joint machine learning model to determine a sequence of events for resolving the issue, wherein the joint machine learning model is trained based at least in part on prior requests and sequences of events corresponding to the prior requests; and
output said determined sequence of events for resolving the issue to one or more additional users.

11. The computer program product of claim 10, wherein the multimodal data comprise at least two of:
text data;
image data;
audio data; and
video data.

12. The computer program product of claim 10, wherein said generating comprises generating a vector representation for (i) the queue state information and (ii) the data corresponding to each of the at least two modalities.

13. The computer program product of claim 10, wherein the queue state information comprises at least one of:
a number of pending cases;
a queue throughput;
a number of resources; and
a number of cases which have been delayed.

14. The computer program product of claim 10, wherein the plurality of case attributes comprises at least two of:
an invoice amount;
an invoice date;
an identifier associated with the user;
an identifier associated with the one or more of product and service; and
payment terms.

15. The computer program product of claim 10, wherein the program instructions cause the computing device to:
estimate a processing time for resolving the issue based on said determined sequence of events.

16. The computer program product of claim 10, wherein the determined sequence of events comprises one or more of:
arranging a third-party to remedy the issue;
initiating a return of the one or more of the product and the service; and
reimbursing, at least in part, the user for one or more of the service and product.

17. The computer program product of claim 16, wherein the program instructions cause the computing device to:
automatically cause performance of one or more of the determined sequence of events.

18. A system comprising:
a memory; and
at least one processor operably coupled to the memory and configured for:
receiving a request from a user to resolve an issue related to one or more of a product and a service, wherein the request comprises multimodal data corresponding to at least two modalities;
creating a case based on the request, wherein the case comprises a plurality of case attributes corresponding to (i) queue state information related to a status of one or more other pending requests and (ii) the multimodal data;
generating a vector representation for the case based at least in part on the plurality of case attributes;
providing the vector representation as input to a joint machine learning model to determine a sequence of events for resolving the issue, wherein the joint machine learning model is trained based at least in part on prior requests and sequences of events corresponding to the prior requests; and
outputting said determined sequence of events for resolving the issue to one or more additional users.

19. A computer-implemented method, comprising:
obtaining a joint machine learning model for determining a complete trace for processing requests related to one or more of a product and a service, wherein the joint machine learning model is trained based at least in part on historical requests and sequences of events corresponding to the historical requests;
receiving a new request related to the one or more of the product and the service, the new request comprising data corresponding to at least two different modalities;
obtaining queue information corresponding to a status of at least one other pending request;
generating a combined vector representation of the new request, wherein said generating comprises generating and concatenating vector representations of (i) the data corresponding to each of the at least two modalities and (ii) the queue information corresponding to the status of the at least one other pending request; and
determining a complete trace of events for processing the new request by providing the combined vector representation as input to the joint machine learning model;
wherein the method is carried out by at least one computing device.

20. The computer-implemented method of claim 19, wherein the joint machine-learning model comprises two or more of:
a convolutional neural network;
a recurrent neural network; and
a long short-term memory (LSTM) network.
